(19) United States
(12) Patent Application Publication
(10) Pub. No.: US 2020/0027341 A1
(43) Pub. Date: Jan. 23, 2020

(54) METHOD AND DEVICE IN A MOTOR VEHICLE FOR MINIMIZING DAMAGE IN THE CASE OF ACCIDENT SITUATIONS

(71) Applicant: Robert Bosch GmbH, Stuttgart (DE)

(72) Inventors: Florian Drews, Renningen (DE); Heiko Freienstein, Weil Der Stadt (DE); Jochen Wieland, Renningen (DE); Joram Berger, Weissach (DE)

(21) Appl. No.: 16/494,045

(22) PCT Filed: Feb. 21, 2018
(86) PCT No.: PCT/EP2018/054233

§ 371 Date: Sep. 13, 2019

(30) Foreign Application Priority Data
Mar. 16, 2017 (DE) 10 2017 204 416.0

(51) Int. Cl. G08G 1/01; G01C 21/34; G05D 1/02; G01C 21/36; G06F 17/18

(52) U.S. Cl. CPC G08G 1/0133; G01C 21/3415; G06F 17/18; G01C 21/3617; G05D 1/0214

(57) ABSTRACT

A device and method for triggering an automatic response of a motor vehicle to an imminent accident situation by using data in a processing unit to create a traffic situation model of the existing traffic situation, analyzing a traffic situation and ascertaining response options, determining sequences to be expected beyond the primary accident incorporating subsequent movements of the road users and objects involved leading to secondary accidents or further subsequent accidents or potentially arising further hazardous situations, computing a probability distribution and/or an extent of injuries to persons and/or damage to objects of the road users and objects involved as a function of the response options, selecting that response option that is expected to have the smallest total degree of probability or the smallest extent of injury to persons and/or damage to objects overall for all road users and objects, and outputting control signals to initiate the selected response option.

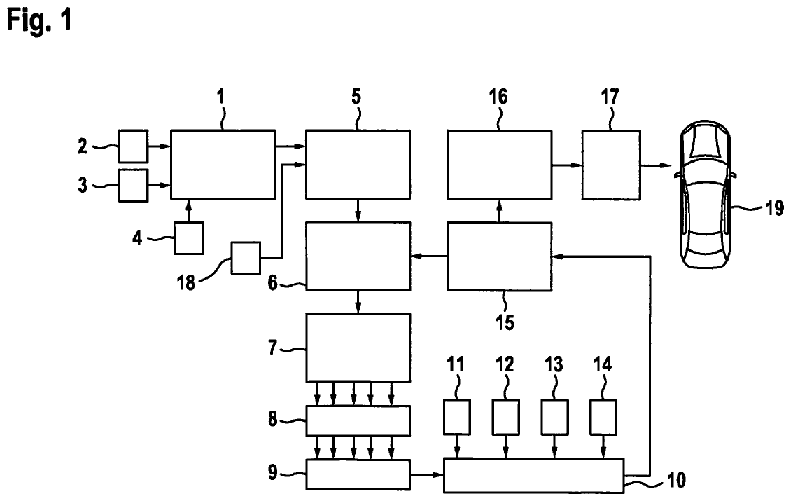

### CROSS-REFERENCE TO RELATED APPLICATIONS

The present application is the national stage of International Pat. App. No. PCT/EP2018/054233 filed Feb. 21, 2018, and claims priority under 35 U.S.C. § 119 to DE 10 2017 204 416.0, filed in the Federal Republic of Germany on Mar. 16, 2017, the content of each of which are incorporated herein by reference in their entireties.

### FIELD OF THE INVENTION

The present invention relates to a method for integrally evaluating a potential accident situation even prior to an accident, in order to be able to initiate measures for minimizing the damage and/or the aggregate risk as well as a corresponding device for carrying out the method. In this case, all of the following contemplations take place from one's own motor vehicle, the so-called host vehicle.

### BACKGROUND

Active and passive occupant protection systems play an increasingly larger role in the further development of vehicles. To be able to achieve an optimal protective effect, a very early accident detection is necessary. Such an accident detection and the activation of the occupant protection systems are based on sensor systems including one or more sensors that are combined to form one or more sensor units, for example, and whose signals are evaluated for the purpose of detecting an impact with an object and/or for the purpose of detecting a rollover of the vehicle, in order to subsequently activate the occupant protection means, which can be designed as irreversible restraint systems, for example airbags or pyrotechnical seat belt tensioners, and/or reversible restraint systems, for example electromotive seat belt tensioners. Various sensor principles, for example acceleration sensors, pressure sensors, structure-borne noise sensors, piezoelectric and/or optical sensors, etc., can be used for the individual sensors. In addition, anticipatory sensor systems, so-called pre-crash sensor systems, are known that include video sensors, LIDAR sensors, ultrasonic sensors or radar sensors, for example, in order to detect an imminent contact with an object and to carry out an object classification.

It is moreover known to activate a brake function using a secondary collision mitigation function (SCM function) in the case of a primary accident that has occurred, in order to eliminate the kinetic energy from the vehicle or to prevent a secondary accident. The SCM function uses the evaluations of a control unit, for example an airbag control unit, to detect a collision as the sensor information, in order to transmit a corresponding actuating signal to a brake control unit following a collision. The general objective of the SCM function is to prevent a potential second collision of the vehicle or to at least reduce the vehicle speed, so that a lower collision speed is present in the case of a second impact, it also being possible to stabilize the movement of the vehicle through targeted brake interventions. The time period between the detection of the primary accident and the point in time at which a significant speed reduction takes place, is the main variable in this case, since this is what determines the benefit of the system. Such an advanced system for intensive brake application following a primary accident, in which the host vehicle has not yet come to a standstill, is known from DE 10 2009 002 815 A1, using which potential further consequences of the primary accident are to be mitigated.

It is also known from EP 1 824 707 B1, for example, to evaluate numerous pieces of information from sensors and other sources, to be able to detect an imminent accident and to carry out an automatic emergency braking action (AEB) in the case of imminent accidents detected as unavoidable, in order to reduce the consequences of the accidents.

When developing comprehensive driver assistance systems and autonomously driving vehicles, increasingly comprehensive data are available in a motor vehicle from navigation systems, information networks, and from systems scanning the surroundings of the motor vehicle. These allow for the instantaneous surroundings and the present driving situation to be detected sufficiently accurately ahead of a potential accident and for potential accident scenarios and their effect on the occupants of the host vehicle as well as on other road users to be computed, in order to potentially keep the damage to persons and objects preferably to a minimum by activating appropriate measures. Here, ethical contemplations also play a role, the prevention of fatal or serious injuries of the persons involved generally having priority. Damage to objects is also contemplated at a subordinate level. All the current contemplations primarily deal with the primary accident to be expected and its maximum mitigation.

### SUMMARY

Starting therefrom, example embodiments of the present invention are directed to a method and a corresponding control unit for also incorporating foreseeable or potential damage to persons and/or objects as a result of subsequent processes, in particular subsequent accidents. This incorporation of subsequent events takes place already during the first responses to an imminent accident situation.

When analyzing an anticipated accident situation and the measures to be potentially initiated for the purpose of mitigating the damage, it is not always sufficient to only contemplate the damage of the primary accident in order to trigger a suitable response to mitigate this damage. In fact, accident situations often result in entire series of accidents, for example when a vehicle ricochets from a guardrail and swerves into the oncoming traffic. Following accident events and depending on their sequences, the vehicles involved (also referred to in the following as objects, together with their cargo and other items) or road users can come to a stop or lie at different locations, at which there is more or less risk for further subsequent accidents. If, for example, following a collision a bicycle rider comes to lie in the oncoming lane of the primary accident and if a vehicle is approaching on this roadway, the consequences can be significantly worse than if the bicycle rider came to lie on an adjacent sidewalk or a lawn. Also, if a vehicle swerves into a body of water or into a slope following a primary accident, the consequences can be severe. For this reason, the method described here provides a preferably deep analysis of imminent accident events depending on the still possible response options that can be used to influence the accident events. To achieve this, it is advantageous to have a preferably accurate model of the surroundings and preferably accurate data about the type, properties, and speeds of the other road users in the instantaneous surroundings. The data available can be used to analyze as a function of their accuracy—accident sequences for different response options performed for the purpose of influencing.

A good pool player contemplates not only the first collision in the case of a planned shot, but computes for different shot directions the subsequent collisions of the balls and the locations at which these will finally come to a standstill following all the collisions. A comparable course of action is applied in the case of the above-described method, which is why the phrase “crash billiard” is also used for this method for analyzing imminent accidents.

This means that an advance calculation of preferably all occurring collisions in the subsequent events of the primary accident takes place, in fact for all or the most important response options that are still available prior to the accident. Moreover, the hazard potential for the situation following the accident is taken into account. The measure customary until now, which is to reduce the kinetic energy following a primary accident preferably intensively, in particular by braking, is not always a suitable means to minimize the damage or risks following the primary accident. If, for example, one of the vehicles involved in the accident comes to a standstill transverse to the traffic flow, there is a high risk of a subsequent accident, which, in the case of a lateral impact, can have worse consequences than the primary accident.

As is known in the context of the discussion already started for autonomous driving, criteria, according to which injury to persons and damage to objects can be assessed versus one another, is predefined to the analysis unit. Here, the rule in general is that preventing the risk of fatal or serious injuries is considered as the most important criterion regardless of potential damage to objects. It is more difficult to assess different numbers of differently injured persons versus one another or also major damage to objects versus minor injuries to persons. Here, an appropriate decision table is used that minimizes the injury to persons overall and also the total damage to objects on a subordinate level. Existing classification systems that are not only capable of detecting objects, but are also capable of classification, are very helpful in this case. In this way, particularly vulnerable traffic participants, such as children, pedestrians, or bicycle riders, can be protected in particular.

To predict or simulate the sequence of a primary accident and the subsequent events, physical laws of partially elastic collisions, the preservation of momentum, the preservation of angular momentum, etc., are essentially used if sufficient information is available about the vehicles and objects involved. The mechanical or dynamic properties of the host motor vehicle, for example its rigidness, its mass, its accelerating power, etc., can also be taken into account.

As response options that can influence the events, preferably the steering, the braking and/or the accelerating, possibly also other maneuvers that can be carried out automatically, as well as chronological sequences and combinations of these measures are included in a response options catalog. For all or one selection of these response options adapted to the situation, an analysis is carried out even prior to the accident in order to select the best response or combination.

It is also preferred to incorporate surroundings information into the sequences to be expected, which in general takes place using pieces of information about the location and the nature of the surroundings, such as the ones available from navigation systems and map material. The time of day and/or weather conditions can also be taken into account.

When contemplating the locations at which the road users and vehicles involved come to a standstill following potential subsequent sequences, the occurrence of subsequent incidents can in most cases only be contemplated using probability distributions. In this case, reference must be made to stored probability data, if the anticipatory sensor system was not capable of providing precise information for such a scenario. If a vehicle, in particular at night, comes to a standstill transverse to the oncoming lane, for example, there is a high degree of probability for a severe subsequent accident, while a vehicle that comes to a standstill on its own lane during the day is exposed to a lower risk.

When analyzing different scenarios, measuring inaccuracies of the involved sensor system and/or inaccuracies of other pieces of information are preferably taken into account by weighting their effect on the analysis. Even if in the specific case the analyses cannot always deliver completely accurate results, a significantly lower risk results overall for all involved road users in a plurality of applications.

As the number of autonomous vehicles increases or the different road users are interconnected more intensively, available information about the properties of the road users involved and their possible responses to the sequences to be expected are preferably also taken into account in the analysis. It will be possible to detect whether a potential other party also has protection systems for minimizing the consequences of an accident, it even being possible in the extreme case to coordinate the measures initiated by the host vehicle and by the other party.

An example embodiment of the present invention is directed to a device for a vehicle for detecting and analyzing an imminent accident situation and for outputting control signals for a response for influencing the sequences to be expected. Such a device includes a processing unit for creating a model of the instantaneous surroundings including the road users, terrain properties, and objects located there. There is furthermore an analysis unit for analyzing the traffic situation in the instantaneous surroundings and for detecting an imminent primary accident as well as for analyzing the effects of different response options to potentially influence the sequences to be expected. A prognosis unit in the device is used to compile a probability distribution for damage concerning road users and objects involved by incorporating the subsequent events to be expected following a primary accident and to assess the risk of different scenarios developing following the primary accident. A decision unit is used to select that response option, using which the probable damage and/or risks to be expected of the primary accident and of the subsequent events is/are minimized. The correspondingly selected response option is used by a control unit to output control signals for initiating appropriate measures.

The processing unit preferably includes inputs at least for the data of a navigation system and of an anticipatory surroundings sensor system.

In an example embodiment, decision criteria are predefined for weighting the damage to be expected and the subsequent risks for persons and objects to be expected, the decision criteria being accessible in a memory.

Example embodiments of the present invention are directed to a computer program for carrying out the above-described method as well as a machine-readable memory medium on which this computer program is stored.

Further details of the method or of the device are elucidated in greater detail based on one example embodiment in the drawing.

### BRIEF DESCRIPTION OF THE DRAWINGS

The FIGURE shows a schematic sequence of a method according to an example embodiment of the present invention.

### DETAILED DESCRIPTION

The FIGURE shows a schematic sequence of a method in a safety system of a motor vehicle 19. A processing unit 1 is supplied with data from a navigation system 2, from an anticipatory surroundings sensor system 3 and with surroundings data 4, so that the processing unit 1 is capable of creating a model of the instantaneous traffic situation in the instantaneous surroundings. In a connected classifier 5 that is preferably connected to a database 18, detected road users are identified and/or classified. Together with classifier 5, the model of processing unit 1 illustrates the traffic situation between all detected road users. A connected analysis unit 6 analyzes the traffic situation based on the model and detects potentially hazardous situations. Based on a response options catalog 15, possible measures, in particular steering, braking, accelerating, and combinations thereof, are checked with regard to their effect on the hazardous situation. In the vast majority of cases, measures will be available, using which a hazard can be avoided and which will then be applied.

If, however, analysis unit 6 detects that an accident is inevitable, the sequence of the primary accident to be expected is simulated and analyzed in a primary accident analysis 7 for the case that no measures whatsoever are initiated. In this case, it is also ascertained, whether the road users will still be in motion following the primary accident and what secondary accidents will occur. The latter are then simulated in a secondary accident analysis 8 that is carried out for all road users and objects involved. The subsequent accidents following thereafter are also simulated and analyzed in a subsequent accident analysis 9, in fact within the scope of the available data, preferably until all involved vehicles, road users, and objects have come to stand or lie. The accuracy of the simulations can naturally decrease in the case of a larger number of steps, however all scenarios and stop positions can be assigned a probability or a probability distribution. The above-described method is also characterized in that the stop positions of all accident participants are each linked to a risk assessment in a prognosis unit 10. A vehicle that comes to a standstill sideways on an oncoming lane, for example, is exposed to a higher risk of further collisions than a vehicle at the roadside. A lying pedestrian is in greater danger on a road than on a sidewalk. Therefore, a first risk assessment 11 assigns a risk to a first stop position, a second risk assessment 12 assigns a different risk to a different accident participant in a second stop position, a third risk assessment 13 assigns a risk to a third stop position of a third accident participant, and so forth until nth risk assessment 14 for an nth stop position. Prognosis unit 10 stores all damage to persons and objects to be expected in the primary accident and the secondary and following accidents and links it to the weighted risks of the stop positions of the other parties/persons in order to ascertain a total damage therefrom.

After that, at least one measure or a combination of measures is selected from response options catalog 15 as the response option, using which the accident situation can be influenced. The entire computation is repeated assuming that this measure/these measures is/are applied, so that a different sequence of the accident results, including a different total damage to be expected. This process is carried out for a plurality, for example all, selections of response options of the response options catalog, so that in the end, the particular total damage is computed for a plurality, for example all, different accident scenarios. A decision unit 16 selects therefrom the scenario involving the most favorable total damage according to predefined standards (possibly also taking into account ethical points of view), so that corresponding control signals are output by a control unit 17 and the corresponding response option that results in the most favorable scenario is carried out on motor vehicle 19.

At multiple points, the above-described sequences can result in the situation that an absolutely precise sequence cannot be ascertained, but only a probability distribution for certain incidents or locations. Whether an injury to a person that is expected at a certain probability actually occurs and how the probability distribution actually manifests itself for the different stop positions of a road user, is however of subordinate importance to the method as long as a scenario entailing the smallest degree of probability of damage or injuries can be selected and brought about.

1-12. (canceled)

13. A method comprising:
a processor creating a model of an existing traffic situation using data from sensor and/or information systems of a motor vehicle;
the processor analyzing the model of the existing traffic situation;
the processor identifying an imminent primary accident and ascertaining response options for responding to the primary analysis based on the analysis;
the processor predicting sequences to possibly occur beyond a primary accident, the sequences incorporating subsequent movements of road users and objects involved up to secondary accidents or hazardous situations;
the processor computing for the response options and based on the predicted sequences a probability or extent of injury to persons and/or damage to objects of the road users and the involved objects involved;
the processor determining which of the response options has been computed to have, compared to all others of the response options, a smallest of the probabilities or extents of injury; and
the processor outputting control signals to trigger the motor vehicle to initiate the determined one of the response options to automatically respond to the imminent primary accident.

14. The method of claim 13, wherein one or more of the response options includes one or more of an automatic steering, a braking, and/or an accelerating performed simultaneously or in a sequence.

15. The method of claim 13, wherein surroundings information are incorporated into the prediction of the sequences.

16. The method of claim 15, wherein the surroungings information includes information about areas in surroundings of the motor vehicle that are hazardous for subsequent movements.

17. The method of claim 13, wherein the probability or extent computation includes consideration of possible hazards arising in stop positions that are predicted to occur following the respective sequences as a result of the primary accident and/or the predicted following sequences, in which stop positions road users and/or objects involved come to a standstill following the respective sequences.

18. The method of claim 13, wherein measuring inaccuracies of the sensor and/or information system and/or inaccuracies of other information of the motor vehicle are taken into account by weighting their effect in the computation of the probability or extent.

19. The method of claim 13, wherein mechanical and dynamic properties of the motor vehicle are taken into account in the computation of the probability or extent.

20. The method of claim 13, wherein available information about properties of the road users involved and their possible responses to the sequences are taken into account in the computation of the probability or extent.

21. A device of a motor vehicle comprising:
a processor; and
at least one interface;
wherein the processor is configured to:
create a model of an existing traffic situation using data obtained via the at least one interface from sensor and/or information systems of the motor vehicle;
analyze the model of the existing traffic situation;
identify an imminent primary accident and ascertain response options for responding to the primary analysis based on the analysis;
predict sequences to possibly occur beyond a primary accident, the sequences incorporating subsequent movements of road users and objects involved up to secondary accidents or hazardous situations;
compute for the response options and based on the predicted sequences a probability or extent of injury to persons and/or damage to objects of the road users and the involved objects involved;
determine which of the response options has been computed to have, compared to all others of the response options, a smallest of the probabilities or extents of injury; and
output via the at least one interface control signals to trigger the motor vehicle to initiate the determined one of the response options to automatically respond to the imminent primary accident.

22. The device of claim 21, wherein the processor is configured to create the model, predict the sequences, and/or compute the probability or extent based on data obtained from a navigation system.

23. The device of claim 21, wherein the processor is configured to create the model, predict the sequences, and/or compute the probability or extent based on data obtained from an anticipatory surroundings sensor system.

24. The device of claim 21, wherein the processor is configured to perform risk assessments for different stop positions at which the road users are predicted to come to a standstill.

25. A non-transitory computer-readable medium on which are stored instructions that are executable by a processor and that, when executed by the processor, cause the processor to perform a method, the method comprising:
creating a model of an existing traffic situation using data from sensor and/or information systems of a motor vehicle;
analyzing the model of the existing traffic situation;
identifying an imminent primary accident and ascertaining response options for responding to the primary analysis based on the analysis;
predicting sequences to possibly occur beyond a primary accident, the sequences incorporating subsequent movements of road users and objects involved up to secondary accidents or hazardous situations;
computing for the response options and based on the predicted sequences a probability or extent of injury to persons and/or damage to objects of the road users and the involved objects involved;
determining which of the response options has been computed to have, compared to all others of the response options, a smallest of the probabilities or extents of injury; and
outputting control signals to trigger the motor vehicle to initiate the determined one of the response options to automatically respond to the imminent primary accident.
